(19) United States
(12) Patent Application Publication
(10) Pub. No.: US 2011/0320294 A1
(43) Pub. Date: Dec. 29, 2011

(54) ACTIVE BUDGET CONTROL

(75) Inventors: Elizabeth S. Votaw, Potomac, MD (US); Christopher Thomas Guess, Geneva, IL (US); Raymond Guy Johns, Wheaton, IL (US)

(73) Assignee: BANK OF AMERICA CORPORATION, Charlotte, NC (US)

(21) Appl. No.: 12/821,631

(22) Filed: Jun. 23, 2010

(51) Int. Cl. G06Q 40/00; G06Q 20/00; G06Q 10/00; G06Q 30/00

(52) U.S. Cl. 705/17; 705/35; 705/39; 705/43

(57) ABSTRACT

A system and method that assists a customer with budgeting includes receiving, at a processor, customer input indicating the customer's desire to create one or more budgeting accounts each defined to correspond with one or more items included in a customer spending budget. The method also includes receiving, at a processor, customer input regarding one or more rules corresponding to the one or more budgeting accounts. The rules, in various embodiments, include one or more funding rules configured to provide parameters for dictating credits for one or more budgeting accounts and/or one or more withdrawal rules configured to provide parameters for dictating debits for one or more budgeting accounts. The method also includes creating, using a processor, one or more budgeting accounts based at least in part on the received customer input. In some embodiments, a processing device applies the rules during a transaction and updates the one or more budgeting accounts.

### FIELD

In general, embodiments of the invention relate to methods, systems, and computer program products for assisting a customer with budgeting using one or more budgeting accounts.

### BACKGROUND

Many financial institutions provide customers an opportunity to view information regarding their deposit accounts in an online setting. In some instances, the financial institution also enables interactive functionality such as performing transactions through the online banking interface. Some financial institutions provide budget assistance tools for analyzing a customer's past spending habits with regard to specific categories of budget items and with regard to, typically, a single deposit account. Additionally, third parties have developed tools for assisting customers in managing their budgets. As with the financial institution tools, the third party tools analyze the customer's spending habit with regard to one account after the transaction(s) have occurred. Additionally, a drawback to use of the third party tools is the transfer of sensitive financial information either from the customer or the customer's financial institution to the third party.

Therefore, a system for providing the customer proactive and real-time budget assistance and control is needed.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., systems, computer program products, and/or other devices), methods, or a combination of the foregoing for assisting a customer with budgeting.

According to one embodiment of the present invention, a method for assisting a customer with budgeting includes receiving, at a processor, customer input indicating the customer's desire to create one or more budgeting accounts each defined to correspond with one or more items included in a customer spending budget. The method also includes receiving, at a processor, customer input regarding one or more rules corresponding to the one or more budgeting accounts. Additionally, the method includes creating, using a processor, one or more budgeting accounts based at least in part on the received customer input.

In some embodiments, the one or more rules include one or more funding rules configured to provide parameters for dictating credits for one or more budgeting accounts. In some such embodiments, the funding rules are further configured to provide parameters dictating automatic, periodic credits for one or more budgeting accounts. In other such embodiments, the funding rules are further configured to provide parameters dictating automatic credits for one or more budgeting accounts and the method further includes receiving a deposit into a primary account maintained by a financial institution, applying the parameters provided by the funding rules comprising determining one or more amounts to be debited from the primary account and credited to the one or more budgeting accounts, debiting the primary account based at least in part on applying the parameters, and crediting the one or more budgeting accounts based at least in part on applying the parameters. In some such embodiments, the received deposit is an automatic direct deposit.

In some embodiments, the one or more rules include one or more withdrawal rules configured to provide parameters for dictating debits for one or more budgeting accounts. In some such embodiments, the withdrawal rules are further configured to provide parameters dictating automatic, periodic debits for one or more of the budgeting accounts. In other such embodiments, the method includes receiving customer input from a customer interface device and the customer input includes choosing one or more budgeting accounts to debit during completion of a transaction at a point of sale. In those embodiments, the method also includes receiving customer payment information and debiting the one or more budgeting accounts based on the customer input and customer payment information. In some such embodiments, the method also includes communicating confirmation of transaction completion to the customer device.

In some embodiments, the method includes authenticating the customer at an automated teller machine (ATM), receiving customer input initiating an ATM deposit transaction at the ATM, receiving customer input choosing one or more budgeting accounts to credit and input regarding credit split amounts, and crediting the one or more budgeting accounts based at least in part on the received customer input.

In some embodiments, the method also includes authenticating the customer at an automated teller machine (ATM), receiving customer input initiating an ATM transfer transaction at the ATM, receiving customer input choosing zero or more budgeting accounts to credit and input regarding credit split amounts, receiving customer input choosing zero or more budgeting accounts to debit, receiving customer input specifying the transfer amount, crediting the zero or more budgeting accounts based at least in part on the received customer input, and debiting the zero or more budgeting accounts based at least in part on the received customer input.

In some embodiments, the method also includes authenticating the customer at an automated teller machine (ATM), receiving customer input initiating an ATM withdrawal transaction at the ATM, receiving customer input choosing one or more budgeting accounts to debit and input regarding debit amount, and debiting the one or more budgeting accounts based at least in part on the received customer input.

According to another embodiment of the present invention, a computer program product includes a non-transitory computer-readable medium including computer executable instructions. The instructions are for assisting a customer with budgeting and include instructions for receiving customer input indicating the customer's desire to create one or more budgeting accounts each defined to correspond with one or more items included in a customer spending budget, instructions for receiving customer input regarding one or more rules corresponding to the one or more budgeting accounts, and instructions for creating one or more budgeting accounts based at least in part on the received customer input.

In some embodiments, the instructions for receiving customer input regarding one or more rules include instructions for receiving customer input regarding one or more funding rules configured to provide parameters for dictating credits for one or more budgeting accounts. In some such embodiments, the instructions for receiving customer input regarding one or more rules include instructions for receiving customer input regarding one or more funding rules further configured to provide parameters dictating automatic, periodic credits for one or more budgeting accounts. In some such embodiments the instructions for receiving customer input regarding one or more rules comprises instructions for receiving customer input regarding one or more funding rules are further configured to provide parameters dictating automatic credits for one or more budgeting accounts. The instructions also include instructions for receiving a deposit into a primary account maintained by a financial institution, instructions for applying the parameters provided by the funding rules comprising determining one or more amounts to be debited from the primary account and credited to the one or more budgeting accounts, instructions for debiting the primary account based at least in part on applying the parameters, and instructions for crediting the one or more budgeting accounts based at least in part on applying the parameters. In some such embodiments, the received deposit is an automatic direct deposit.

In some embodiments, the instructions for receiving customer input regarding one or more rules include instructions for receiving customer input regarding one or more withdrawal rules configured to provide parameters for dictating debits for one or more budgeting accounts. In some such embodiments, the withdrawal rules are further configured to provide parameters dictating automatic, periodic debits for one or more of the budgeting accounts. In some such embodiments, the instructions also include instructions for receiving customer input from a customer interface device, the customer input comprising choosing one or more budgeting accounts to debit during completion of a transaction at a point of sale, instructions for receiving customer payment information, and instructions for debiting the one or more budgeting accounts based on the customer input and customer payment information. In some of these embodiments, the instructions also include instructions for communicating confirmation of transaction completion to the customer device.

In some embodiments, the instructions also include instructions for authenticating the customer at an automated teller machine (ATM), instructions for receiving customer input initiating an ATM deposit transaction at the ATM, instructions for receiving customer input choosing one or more budgeting accounts to credit and input regarding credit split amounts, and instructions for crediting the one or more budgeting accounts based at least in part on the received customer input.

In some embodiments, the instructions also include instructions for authenticating the customer at an automated teller machine (ATM), instructions for receiving customer input initiating an ATM transfer transaction at the ATM, instructions for receiving customer input choosing zero or more budgeting accounts to credit and input regarding credit split amounts, instructions for receiving customer input choosing zero or more budgeting accounts to debit, instructions for receiving customer input specifying the transfer amount, instructions for crediting the zero or more budgeting accounts based at least in part on the received customer input, and instructions for debiting the zero or more budgeting accounts based at least in part on the received customer input.

In some embodiments, the instructions also include instructions for authenticating the customer at an automated teller machine (ATM), instructions for receiving customer input initiating an ATM withdrawal transaction at the ATM, instructions for receiving customer input choosing one or more budgeting accounts to debit and input regarding debit amount, and instructions for debiting the one or more budgeting accounts based at least in part on the received customer input.

According to another embodiment of the present invention, a system assists a customer with budgeting, and includes a processing device configured for receiving customer input indicating the customer's desire to create one or more budgeting accounts each defined to correspond with one or more items included in a customer spending budget, receiving customer input regarding one or more rules corresponding to the one or more budgeting accounts, and creating one or more budgeting accounts based at least in part on the received customer input. In some embodiments, the processing device is also configured for receiving one or more funding rules configured to provide parameters for dictating credits for one or more budgeting accounts. In some such embodiments, the processing device is also configured for receiving one or more funding rules configured to provide parameters dictating automatic, periodic credits for one or more budgeting accounts.

In some embodiments, the processing device is also configured for receiving one or more funding rules configured to provide parameters dictating automatic credits for one or more budgeting accounts, receiving a deposit into a primary account maintained by a financial institution, applying the parameters provided by the funding rules comprising determining one or more amounts to be debited from the primary account and credited to the one or more budgeting accounts, debiting the primary account based at least in part on applying the parameters, and crediting the one or more budgeting accounts based at least in part on applying the parameters. In some such embodiments, the received deposit is an automatic direct deposit.

In some embodiments, the processing device is also configured for receiving one or more withdrawal rules configured to provide parameters for dictating debits for one or more budgeting accounts. In some such embodiments, the withdrawal rules are further configured to provide parameters dictating automatic, periodic debits for one or more of the budgeting accounts.

In other embodiments, the system also includes a point of sale terminal coupled with the first processing device. In such embodiments, the point of sale terminal includes a second processing device configured for receiving customer input from a customer interface device, the customer input comprising choosing one or more budgeting accounts to debit during completion of a transaction at the point of sale terminal, receiving customer payment information. In such embodiments, the first processing device is configured for debiting the one or more budgeting accounts based on the customer input and customer payment information. In some such embodiments, the system also includes a communication device coupled with the customer interface device and configured for communicating confirmation of transaction completion to the customer interface device.

In some embodiments, the system also includes a customer interface device coupled with the processing device. The customer interface device is configured for authenticating the customer, receiving customer input initiating a deposit transaction at the customer interface device, receiving customer input choosing one or more budgeting accounts to credit and input regarding credit split amounts. The processing device is further configured for crediting the one or more budgeting accounts based at least in part on the received customer input.

In some embodiments, the system also includes a customer interface device coupled with the processing device. The customer interface device is configured for authenticating the customer at the customer interface device, receiving customer input initiating a transfer transaction at the customer interface device, receiving customer input choosing zero or more budgeting accounts to credit and input regarding credit split amounts, receiving customer input choosing zero or more budgeting accounts to debit, receiving customer input specifying the transfer amount. The processing device is further configured for crediting the zero or more budgeting accounts based at least in part on the received customer input and debiting the zero or more budgeting accounts based at least in part on the received customer input.

In some embodiments, the system includes a customer interface device coupled with the processing device. The customer interface device is configured for authenticating the customer at the customer interface device, receiving customer input initiating a withdrawal transaction at the customer interface device, receiving customer input choosing one or more budgeting accounts to debit and input regarding debit amount. The processing device is further configured for debiting the one or more budgeting accounts based at least in part on the received customer input.

According to another embodiment of the present invention, a method assists a customer with budgeting. The method includes receiving, using a processor, a transaction initiation request initiating a transaction involving one or more of a customer's one or more budgeting accounts each defined to correspond with one or more items included in a customer spending budget, accessing, using a processor, one or more predefined rules configured to provide one or more transaction parameters for the one or more budgeting accounts, applying, using a processor, the one or more transaction parameters for the one or more budgeting accounts involved in the transaction, and updating, using a processor, the one or more budgeting accounts involved in the transaction. In some such embodiments, the method includes authenticating a customer at a customer interface device, and wherein receiving a transaction initiation request initiating a transaction includes receiving, at a processor, customer input indicating a type of desired transaction involving the one or more budgeting accounts. In some such embodiments, the customer interface device comprises an online banking interface. In other such embodiments, the customer interface device comprises an automated teller machine (ATM). In yet other such embodiments, the customer interface device comprises a point of sale terminal.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a block diagram illustrating an online banking environment according to one embodiment of the present invention.

FIG. 2A is a block diagram illustrating a banking network according to one embodiment of the present invention.

FIG. 2B is a block diagram illustrating a banking network according to another embodiment of the present invention.

FIG. 3 is a flowchart illustrating a method for initiating one or more budgeting accounts according to one embodiment of the present invention.

FIG. 4 is a flowchart illustrating a method for distributing a customer deposit into one or more budgeting accounts according to one embodiment of the present invention.

FIG. 5 is a flowchart illustrating a method for providing payment using one or more budgeting accounts according to one embodiment of the present invention.

FIG. 6 is a flowchart illustrating a method for providing an automated teller machine (ATM) transaction using one or more budgeting accounts according to one embodiment of the present invention.

FIG. 7 is a flowchart illustrating a method for applying one or more rules during a transaction involving one or more budgeting accounts according to another embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention provide for systems, methods, and computer program products for assisting a customer with budgeting. Assisting a customer with budgeting includes receiving, at a processor, customer input indicating the customer's desire to create one or more budgeting accounts each defined to correspond with one or more items included in a customer spending budget. The method also includes receiving, at a processor, customer input regarding one or more rules corresponding to the one or more budgeting accounts. The rules, in various embodiments, include one or more funding rules configured to provide parameters for dictating credits for one or more budgeting accounts and/or one or more withdrawal rules configured to provide parameters for dictating debits for one or more budgeting accounts. The method also includes creating, using a processor, one or more budgeting accounts based at least in part on the received customer input. In some embodiments, a processing device applies the rules during a transaction and updates the one or more budgeting accounts.

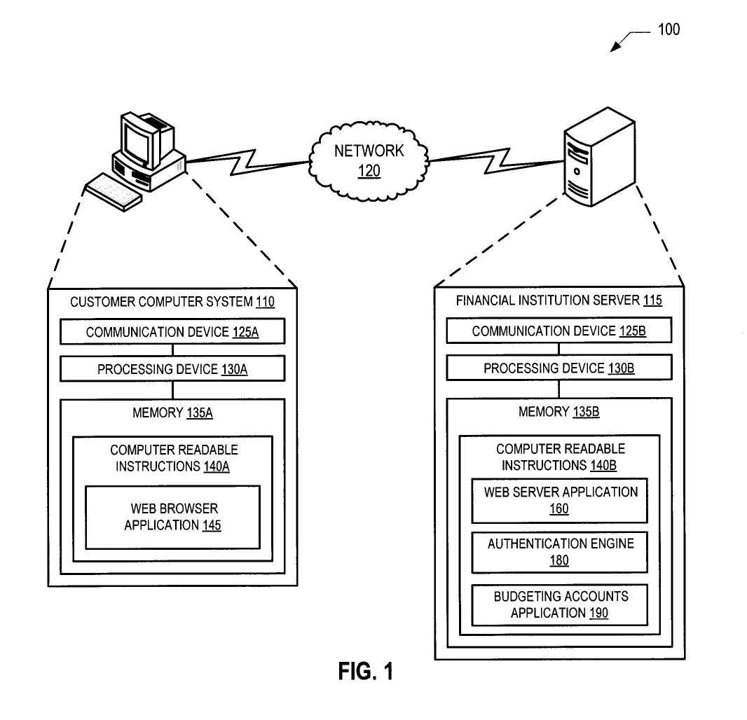

Referring to FIG. 1, a block diagram of an online banking environment 100 in accordance with some embodiments of the present invention is illustrated. A financial institution server 115 is operatively coupled, across a network 120, to one or more customer computer systems 110. The financial institution server 115 includes a communication device 125B configured for communicating across the network 120 with a communication device 125A of the customer computer system 110 and, in some embodiments, other devices, computers, systems, servers or the like. The financial institution server 115 also includes one or more processing devices 130B. Processing device 130B controls the communication device 125B and is configured for accessing a memory 135B configured for storing computer readable or executable instructions 140B. The processing device 130B is configured for accessing and executing the computer readable instructions stored in or at the memory device 135B.

In the illustrated embodiment, the computer readable instructions 140B include a web server application 160, which is configured for rendering a website on the customer's web browser, generated by the web browser application 145 of the customer computer system 110. The web browser application 145 is stored on the computer readable or executable instructions 140A in a memory 135A of the customer computer system 110.

In one embodiment, for example, the financial institution is a bank and the web server application 160 is the bank's online banking application configured to provide content to the web browser application 145 for rendering the bank's online banking interface to the customer. Associated with the financial institution's online banking interface is typically an authentication widget or application, which is rendered by the authentication engine 180 of the financial institution server 115. The authentication engine 180, in some embodiments, renders the authentication widget or program on the customer's web browser once the customer has navigated to the financial institution's website and requested online banking The authentication engine 180 is configured to walk the customer through authentication onto the online banking website whereby the customer, in typical applications, inputs customer authentication information such as username and password. The authentication engine 180 authenticates the information provided by the customer and provides access to the online banking interface to the customer.

The customer computer system 110 also includes a communication device 125A configured for communicating with the financial institution server 115 and, in some embodiments, other devices, computers, systems, servers, or the like. The customer computer system 110 also includes one or more processing devices 130A configured for controlling the communication device 125B and accessing the memory 135A. The processing device is configured for reading and executing the web browser application 145 thereby providing the customer a web browser displayed on the customer computer system 110 for navigating the network 120, such as, for example, visiting web pages via the Internet. In one embodiment, for example, the web browser application 145 interacts with the web server application 160 of the financial institution server 115 as discussed above. In other embodiments, an application-specific application is stored on the memory 135A and executed by the processing device 130A in order to communicate across the network 120 with the financial institution server 115 and/or other devices, computers, systems, servers, or the like. Such an application-specific application, in some embodiments, is focused primarily on the specific application, for example, creating and/or using one or more budgeting accounts as discussed herein. In various embodiments, for example, the customer computer system 110 is or includes one or more of a mobile device such as a smartphone, personal digital assistant (PDA), cellular phone and the like, a laptop computer, a desktop computer, and the like.

The financial institution server 115 also includes computer readable instructions 140B directed to a budgeting accounts application 190. The budgeting accounts application 190, in some embodiments, is configured to initiate creation of one or more budgeting accounts including requesting and receiving customer input regarding the accounts. In some embodiments, this includes facilitating customer definition of one or more rules dictating how the budgeting accounts behave during various types of transactions as discussed in greater detail below. The budgeting accounts application 190 also stores information related to the budgeting accounts such as account identification information including account number or other identifier as well as account nickname in some embodiments. The budgeting accounts application 190 in some embodiments includes instructions for such information to be stored in a separate location such as another computer system, server and/or database, in addition to storing at the financial institution server 115 or in lieu of storing at the financial institution server 115. Further, in some embodiments, the budgeting accounts application 190 includes instructions for applying the one or more rules during a transaction in order to determine appropriate credits and/or debits that should be posted to one or more of the budgeting accounts. The budgeting accounts application 190, in various embodiments, includes additional functionality, such as, for example, instructions for performing various method steps as discussed in greater detail below with reference to the several figures. In some embodiments, the budgeting accounts application 190 is a portion of an overall electronic banking or online banking application maintained by the financial institution.

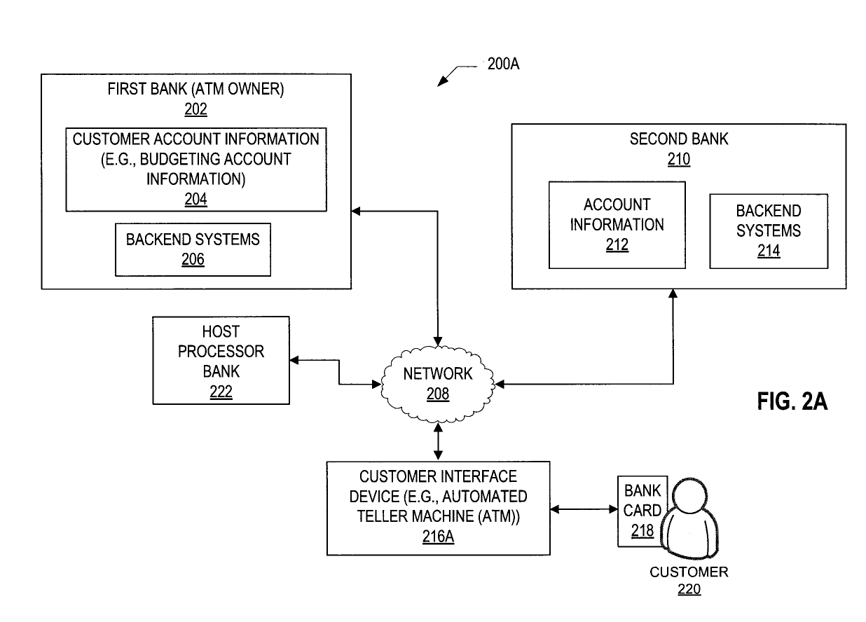

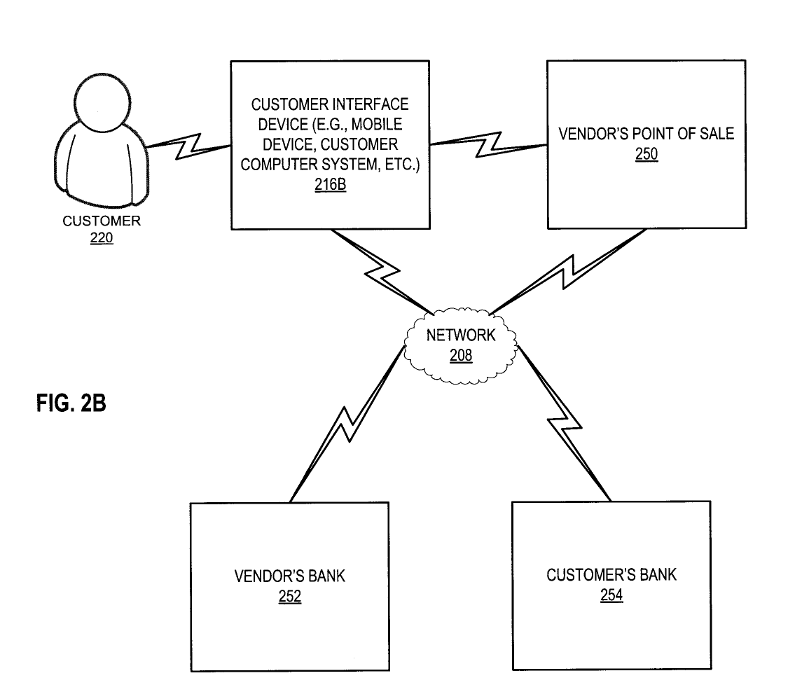

FIGS. 2A and 2B are block diagrams illustrating embodiments of banking networks 200A and 200B. Referring to FIG. 2A, a first bank 202 is typically the bank or other financial institution that maintains and/or owns the customer interface device 216A. The customer interface device 216A, in some embodiments, is an automated teller machine (ATM), and in others it is a device maintained and/or owned by the customer, such as a mobile device or a customer computer system, such as customer computer system 110 of FIG. 1. In the case where the customer interface device is an ATM, the first bank 202 is typically the financial institution that issues a bank card 218 to the customer. In this regard, the first bank 202 includes a memory system housing a datastore of customer account information 204. The memory system housing the customer account information is typically part of or in communication with one or more backend systems 206 maintained by the correspondent bank 202. A “backend system” is one or more computers or computer-like devices such as one or more server systems, and a backend system typically has one or more processing devices such as a server and typically includes one or more memory devices as well as one or more communication devices. One example of an embodiment of a backend system or a component of a backend system is financial institution server 115 shown in FIG. 1. The customer account information 204 generally includes one or more account numbers associated with the one or more budgeting accounts, various other budgeting account information such as budgeting account balances, transaction information about previous transactions and/or scheduled future transactions, and/or other financial and non-financial information about the customer and both the customer's budgeting accounts and/or other accounts, such as other deposit accounts.

The first bank 202 is coupled with a network 208, such as the Internet or some combination of local area networks, wide area networks, intranets and the Internet. Through the network 208, the first bank 202 can communicate with other banks, such as the second bank 210, the host processor bank 222, and other entities such as the customer interface device 216A and thereby the customer 220. The second bank 210, in the embodiment shown, also has backend systems 214 and a memory system housing a datastore of customer account information 212 similar to the datastore of customer account information 204 maintained by the first bank 202.

The banking networks 200A and 200B, in some instances, include a customer 220 having a bank card 218 issued by one of the banks in the network, such as the first bank 202. In various embodiments, the bank card 218 is, for example, a credit, debit, ATM or other type of card including a magnetic stripe, or a smart card or chip card including an electronic device embedded in or on the card. It should be appreciated that, although embodiments of the present invention are generally described herein with reference to “bank cards”, other embodiments of the invention involve use of other customer interface devices and/or payment devices, such as smart phones, near-field communication (NFC) devices, RFID tags, biometric devices, and the like in lieu of the “cards” described herein. The bank card 218 (or other payment device) is used during a transaction involving one or more budgeting accounts owned by the customer 220, associated with the bank card 218 and maintained by the issuing bank, for example, the first bank 202.

The banking network 200A includes a customer interface device 216A (CID) configured to communicate with one or more banks, and in particular the first bank 202. In some instances, the CID 216A communicates through the network 208 directly with the first bank 210. In other embodiments, the CID 216A communicates with the first bank 202 through a host processor bank 222 and/or one or more other banks and/or entities. In some embodiments, the CID owner is the first bank 202, and in other embodiments, the CID owner is another entity such as another bank, the customer, a vendor, a merchant or the like. For example, in the case where the CID 216A is an ATM, many banks have their own ATMs. In such embodiments, the ATMs communicate directly with the ATM owners, typically banks, over the network 208 and/or through one or more other entities.

In one example, the CID 216A is a kiosk-style ATM owned or leased by a merchant from the first bank 202. The merchant, in some embodiments, for example, is a gas station or convenience store. In some embodiments, although an ATM holder (the “merchant” in this example) typically provides the money in the ATM, the ATM is operated by a host processor bank 222. In such an embodiment, the ATM communicates with the first bank 202 through the host processor bank 222. Where the transaction involves a withdrawal of cash from the ATM, the first bank 202 transfers funds to the host processor bank 222 via, for example, an electronic funds transfer, and the host processor bank 222 then transfers the funds via the Automated Clearing House (ACH) to the merchant's bank account maintained by the merchant's bank (not shown). In this way, the ATM holder is reimbursed for the funds dispensed at the ATM.

Referring now to FIG. 2B, a customer 220 interacts with a customer interface device 216B such as a customer computer system, for example customer computer system 110 of FIG. 1, a mobile device, such as a cellular phone, smartphone, personal digital assistant (PDA), personal navigation device such as a GPS receiver, personal music player such as an MPEG Layer 3 (MP3) player, or the like. As discussed in greater detail below, the customer 220 can initiate a transaction, select payment via one or more budgeting accounts (or payment can be pre-selected to debit one or more budgeting accounts automatically), and complete the transaction with a vendor's point of sale 250. The point of sale 250 is coupled with a network 208 in communication with the vendor's bank 252 and the customer's bank 254, which, in some embodiments, is similar to first bank 212 of FIG. 2A, having customer account information stored in a datastore. In one embodiment, the customer interface device 216B communicates across the network directly with the banks 252 and 254 and in another embodiment, the customer interface device 216B communicates with the point of sale 250.

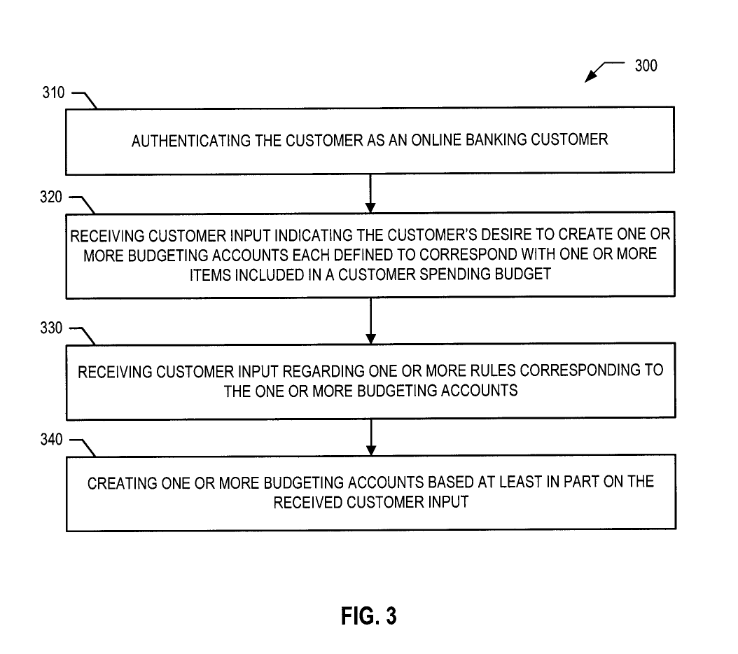

Referring now to FIG. 3 a flowchart illustrates a method 300 for initiating one or more budgeting accounts according to one embodiment of the present invention. As represented by block 310, the first step is authenticating the customer as an online banking customer. In a typical embodiment, authentication involves the financial institution server 115 requesting authentication information from the customer, the customer providing two or more pieces of authentication information indicating to the financial institution server 115 the customer's identity, and the financial institution server 115 providing access to online banking to the customer. In various embodiments, other more or less complicated authentication methods are used, such as using one or more graphical or textual authentication representations to ensure the customer is not a fraudster and that the website the customer is visiting is not designed nefariously to mine customers' sensitive information, such as, for example, if the customer accidentally visits the incorrect website.

As represented by block 320, the next step is receiving customer input indicating the customer's desire to create one or more budgeting accounts each defined to correspond with one or more items included in a customer's spending budget. In one embodiment, for example, the customer selects an option within the online banking website to open a budgeting account. The processing device 130B of the financial institution server 115 as instructed by the budgeting accounts application 190 (FIG. 1) receives the customer input indicating a desire to open the new budgeting account. Each budgeting account typically is associated with or corresponds to one or more items on a customer's spending budget. For example, a customer has a budget that includes several budget items such as “Mortgage”, “Groceries”, “Fun”, “Utilities”, “Car Payment” and the like. A budgeting account can be opened to correspond to each of the individual budget items. The customer, in some embodiments, assigns labels such as those listed above or others identifying the individual budgeting account to the customer. In some cases, of course, the label may have little or no meaning to anyone but the customer. In some embodiments, the customer does not associate the one or more budgeting accounts with budget items, but rather, associates the accounts in some other fashion, such as “General Savings”, “Retirement”, or the like. Once the customer has indicated the desire to create the budgeting accounts and defined them to correspond with the customer's budget items, rules defining the behavior and/or allocation of funds with regard to the budgeting accounts can be established.

As represented by block 330, the next step is receiving customer input regarding one or more rules corresponding to the one or more budgeting accounts. As with step 320, the processing device 130B of the financial institution server 115 as instructed by the budgeting accounts application 190 (FIG. 1) receives the customer input regarding the rules. In some embodiments, the rules establish parameters through which the budgeting accounts are debited and/or credited. For example, in a case where a budgeting account is earmarked as a “Mortgage” account, the customer may want to fund the budgeting account with sufficient funds for his or her mortgage to be paid from the “Mortgage” budget account every month. The customer, knowing that the mortgage payment is $1000.00 per month, establishes a rule that $500.00 should be credited to the “Mortgage” budget account twice a month—corresponding with the customer's bi-monthly paychecks. In some embodiments, the rules are established to debit funds from one or more other accounts, such as a “primary” account or other deposit account owned by the customer. For example, in one embodiment, the customer establishes rules to debit funds from his primary checking account at varying times and amounts throughout the month as necessary to accommodate the customer's budget. The funds are credited to the appropriate budgeting account based on the allocation of the established rules. Once the rules have been established, or in some embodiments, before the rules are established, the budgeting accounts are created.

As represented by block 340, the next step is creating one or more budgeting accounts based at least in part on the received customer input from steps 320 and 330. The budgeting accounts, in some instances are referred to as “sub-accounts” because they are typically earmarked for a very specific purpose, for example, collecting and distributing funds for some particular budget item like the car payment or the groceries. The budgeting accounts, however, retain most or all of the typical characteristics of any other deposit account, such as a checking account, savings account or the like. When the budgeting accounts are created, in some embodiments, they are tied or associated with a “master” account or a “primary” account. In some such instances, the primary account is chosen by the customer based on the customer's past use of the primary account as the customer's primary checking and/or savings account. The primary account, in some embodiments, is the single account from which each of the “sub-account,” budgeting accounts is funded, and in other embodiments, the primary account is only one of several accounts from which the budgeting accounts are funded.

In some embodiments, each budgeting account is assigned an account number, just as any other deposit account. In one embodiment, for example, each budgeting account is a sub-account of a primary account as discussed above. Each budgeting account is assigned an account number based on the account number assigned to the primary account. For example, the primary account number is 0012345678, and each budgeting account is assigned a sub-account number beginning with 01 and progressing to 02, 03, 04, and the like. The sub-account number, in some embodiments, is appended onto the beginning of the primary account's account number after removing the first two digits, which are zeros. Thus, the first budgeting account is assigned an account number of 0112345678, the second budgeting account is assigned an account number of 0212345678, the third is assigned an account number of 0312345678, and so on. Assigning the budgeting account numbers in this way adds an additional level of identification capabilities. The customer, having used the primary deposit account before, is familiar with the account number, and appending the sub-account number onto the beginning of the account number allows the customer to retain the familiar account number with only a slight variation for each budgeting account. A method of assigning account numbers such as this also provides the customer the opportunity to open up to 99 budgeting accounts as sub-accounts to a primary deposit account. In some embodiments, the sub-accounts behave as autonomous deposit accounts such that each of the sub-accounts can be debited and credited manually or automatically through use of the rules-based allocations and bill pay options (as discussed elsewhere) in a variety of ways.

In some embodiments, the sub-accounts are restricted in that they are only credited through allocation from the primary account, thereby removing a degree of complexity in the budgeting process. In other embodiments, the sub-accounts retain some flexibility in their use with regard to debits and credits outside the primary accounts and some is removed. For example, in one embodiment, the sub-accounts of a primary account are allowed, based on the established rules to receive credits only from the primary account, but are allowed to enter into automated bill-pay associations with any other deposit account. In various other embodiments, budgeting accounts are assigned account numbers randomly or based on an account number assignment protocol generally used for deposit accounts without regard to whether the accounts are budgeting accounts or sub-accounts. In other embodiments, the budgeting accounts are assigned a sub-account number, such as a two digit number as described above and the sub-account number is merely tacked onto the beginning or end of the primary account number. In some embodiments, the budgeting accounts are tied to a primary account and in other embodiments, the budgeting accounts are not tied to a primary account.

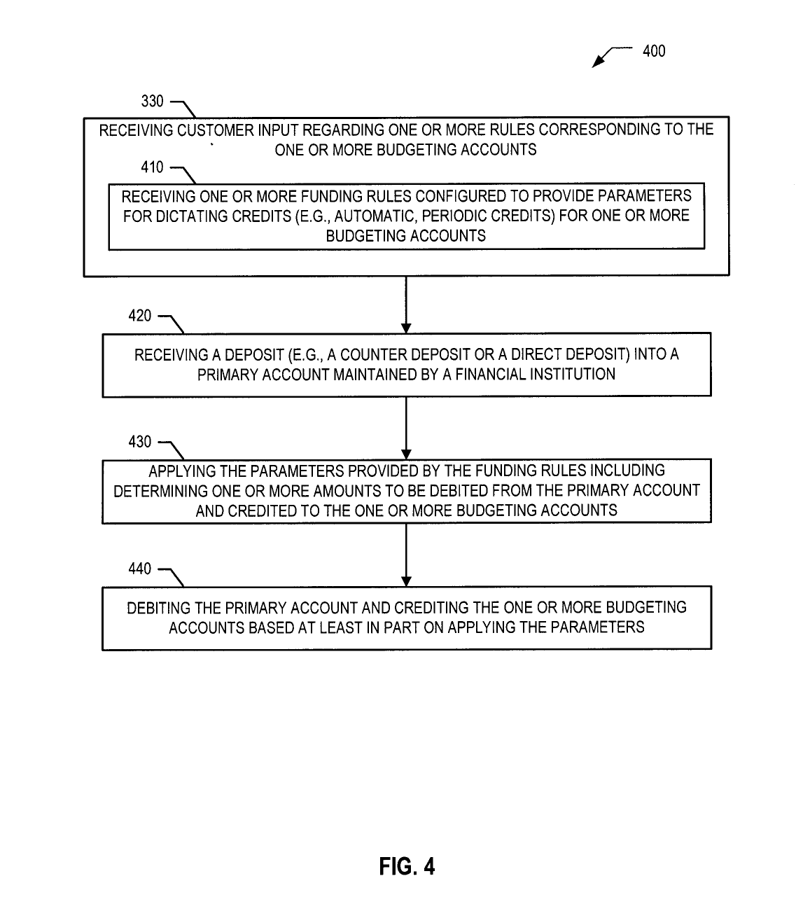

Referring now to FIG. 4, a flowchart illustrating a method 400 for distributing a customer deposit into one or more budgeting accounts according to one embodiment of the present invention is shown. In this embodiment, step 330, receiving customer input regarding one or more rules corresponding to the one or more budgeting accounts, includes receiving one or more funding rules as represented by block 410. The funding rules are configured to provide parameters for dictating credits, such as automatic, periodic credits, for one or more budgeting accounts. The parameters, in some embodiments, include equations and/or filters for determining allocation amounts for the various budgeting accounts. In some embodiments, the parameters include percentages of an amount deposited into a primary account associated with each budgeting sub-account. For example, in one embodiment, the customer has five budgeting accounts and creates the funding rules such that each of the five budgeting accounts receives an equal percentage of the funds deposited into a primary accounts. Thus, if $1000.00 is deposited into the primary account, the funding rules dictate that equal amounts of the $1000.00 are credited to each of the budgeting accounts. As another example, in another embodiment, the customer has ten budgeting accounts and creates funding rules such that each of the ten budgeting accounts receives a set amount of funds each month. For example, the customer has a “Car Payment” budgeting account requiring $300.00 a month in order to pay the customer's car payment. In this case, the customer can define a funding rule such that the Car Payment budgeting account is allocated $300.00 once a month, $150.00 twice a month or some other variation of funding rules such that the budgeting account is sufficiently funded for covering the car payment in a timely fashion.

In some embodiments, the customer must define priorities among the funding rules. In other words, certain rules take precedent over other rules. This prioritizing the allocation of funds among the various budgeting accounts is particularly useful when the customer's income is inconsistent over month to month and/or if the customer's liabilities or bills are inconsistent month to month. Likewise, the customer, in some embodiments, must define priorities among the withdrawal rules as discussed in further detail below. Examples or prioritizing the funding and withdrawal rules are also discussed below.

Block 420 represents receiving a deposit, such as a counter deposit or a direct deposit, into a primary account maintained by a financial institution. Referring concurrently to FIG. 2A, for example, the customer 220 is a customer of the first bank 202 and is an employee of an employer (not shown) having a direct deposit employee payment process. The customer's employer initiates a direct deposit of the customer's paycheck, and the deposit is received by the first bank 202 over the network 208. The first bank 202's backend systems 206 have a processing device that receives information regarding the deposit in some embodiments.

Block 430 represents applying the parameters provided by the funding rules including determining one or more amounts to be debited from the primary account and credited to the one or more budgeting accounts. The processing device of the backend systems 206 of the first bank 202, continuing the example from above, performs this step automatically in most embodiments. Hence, when the deposit information is received by the first bank, in one embodiment, the deposit does not post to the primary account, but rather is automatically allocated based on the funding rules defined by the customer. In another embodiment, when the deposit is received by the first bank 202, the deposit posts to the primary account and the funding rules are applied by the processing device after the deposit posts. This takes place substantially simultaneously to the deposit posting to the primary account in one embodiment, and in another embodiment, the application of the funding rules to the posted deposit amount is performed by the processing device at a later time, for example, one business day or three business days. In some embodiments, such a waiting period before applying the funding rules is dictated by customer preference, and as such, the waiting period is included in the rules received stored, and applied by the financial institution. In yet other embodiments specifically identified deposits, such as “only direct deposits” or “never ATM deposits” are treated differently than other deposits. For example, in one embodiment, certain deposits are posted to the primary account and given a waiting period before funding rules are applied to them, whereas other deposits are immediately allocated based on the funding rules. In yet other embodiments, portions of single deposits are treated differently. For example, in one embodiment, a deposit is divided into thirds where one third is posted to the primary account indefinitely, one third is immediately allocated based on funding rules, and one third is allocated after a period of delay defined by the funding rules. Of course, numerous examples of variations of funding rules including division of individual deposits, allocation of individual and multiple deposits and the like are possible and envisioned within the scope of the invention.

Block 440 represents debiting the primary account and crediting the one or more budgeting accounts based at least in part on applying the parameters from the funding rules. Once deposited amounts have been allocated based on the parameters of the funding rules, the processing device debits the primary account, or in embodiments where the deposit does not post to the primary account, the appropriate source account. The processing device, concurrently, proximally in time, or at different times, credits the budgeting accounts in the amounts allocated based on the parameters of the funding rules.

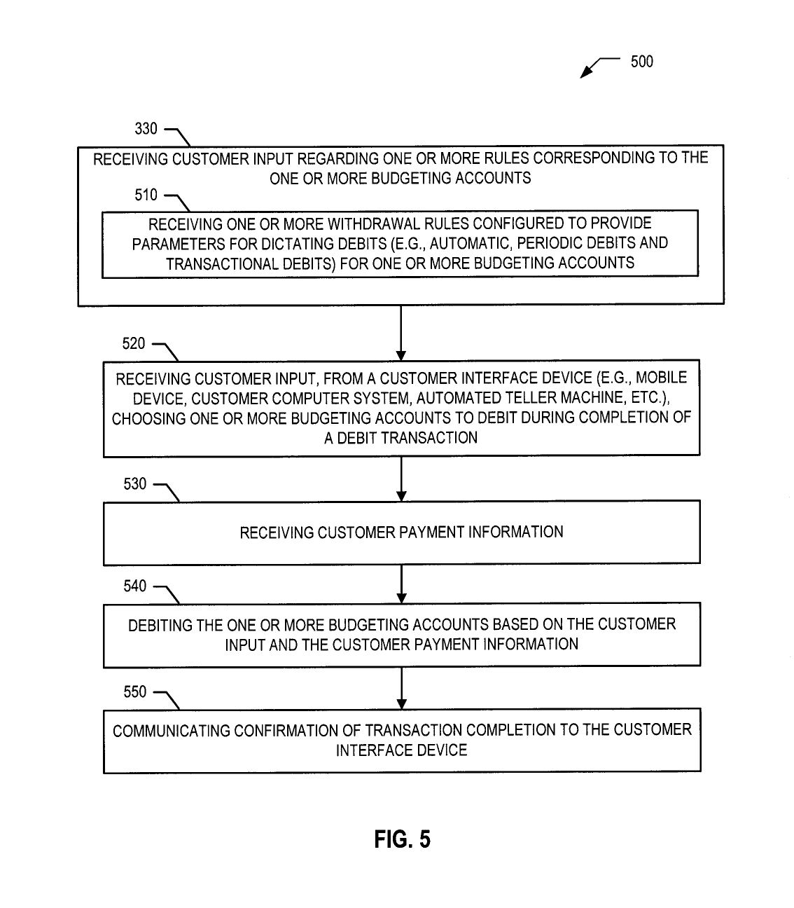

Referring now to FIG. 5, a flowchart illustrating a method 500 for providing payment using one or more budgeting accounts according to one embodiment of the present invention is shown. In this embodiment, step 330, receiving customer input regarding one or more rules corresponding to the one or more budgeting accounts, includes receiving one or more withdrawal rules as represented by block 510. The withdrawal rules are configured to provide parameters for dictating debits, such as automatic, periodic debits and transactional debits, for one or more budgeting accounts. The parameters, in some embodiments, include equations and/or filters for determining allocation amounts for the funds held in the various budgeting accounts. In some embodiments, the parameters include percentages of an amount deposited into a primary account associated with each budgeting sub-account, and in other embodiments, the parameters include information regarding automatic bill-pay processes. For example, in one embodiment, the parameters of the withdrawal rules include information identifying a payee account to be credited with funds debited from one or more budgeting accounts. As a specific example, a “Power Bill” budgeting account is associated with withdrawal rules dictating a monthly bill payment to the power utility provider, which is identified by information stored in the withdrawal rule parameters. Additionally, information concerning a monthly amount to pay or information concerning retrieving payment account balances before performing the automatic bill payment is included in the withdrawal rule parameters. Thus, in this example, the budgeting account, assuming sufficient funding, is automatically debited an amount appropriate for satisfying the outstanding balance of the payment account. In other embodiments, such as those involving transactional debits, additional customer input is sometimes necessary.

Block 520 represents receiving customer input from a customer interface device, such as customer interface device 216A and/or customer interface device 216B of FIGS. 2A and 2B respectively. The customer interface device is, in various embodiments, a mobile device, customer computer system, ATM or the like. The customer input includes choosing one or more budgeting accounts to debit during completion of a debit transaction and is received initially by the customer interface device. Subsequently, in some embodiments, the customer input is communicated from the customer interface device to the processing device of the financial institution server. In some embodiments, the customer interface device is a mobile device configured with an “electronic wallet” or “mobile wallet,” which in one embodiment is an application or widget running on the customer's mobile device enabling the customer to provide payment information at a point of sale. In some embodiments, the debit transaction is not a debit transaction at a point of sale, and the customer interface device is a customer computer system, ATM or another device. In some embodiments the debit transaction is a bill pay transaction such that the customer provides customer input from a customer computer system or some other customer interface device subsequent to the bill pay transaction. The customer, of course, has specified in the withdrawal rules the bill pay parameters, such as, for example, the budgeting accounts involved as well as the payee information.

Block 530 represents receiving customer payment information. The customer payment information, in most embodiments, is input by the customer into the customer interface device, which communicates the payment information to the point of sale, which in turn communicates the payment information to the financial institution server or backend system of the bank. This step is included when the debit transaction is a transaction occurring at a point of sale. As mentioned above, the customer interface device, during a debit transaction at a point of sale, in various embodiments, is a mobile device, a customer computer system or the like. In mobile device embodiments, the mobile device may be equipped with a short range wireless communication capability using standards such as Near Field Communication or Bluetooth communication. In such embodiments, the mobile device functions as a mobile wallet providing the interface with the customer such that the customer can provide the input discussed above with reference to blocks 510 and 520 as well as additional input, such as customer payment information. The customer payment information, in various embodiments, includes one or more account numbers, sub-account numbers, usernames, passwords, other authentication mechanisms, and/or the like. In one embodiment, the mobile wallet of the mobile device has predetermined rules stored locally at the mobile device, or in some embodiments, stored remotely such as at the financial institution server. Such remotely stored rules can be communicated to the mobile device during a transaction across the banking network. The predetermined rules, in some embodiments, are part of the withdrawal rules received from the customer in step 510 and define parameters for providing payment during a point of sale debit transaction. For example, in one embodiment, the customer establishes predetermined mobile wallet withdrawal rules during initiation of her budgeting accounts. The rules are stored on the customer's mobile device, and during a point of sale debit transaction, the rules dictate the budgeting account from which the payment is made based on one or more parameters. The parameters, for example, may include the type of good or service being purchased, the amount of the purchase, the category of the merchant (e.g., restaurant, grocery store, etc.), and the like. Similarly, in embodiments where the customer interface device is not a mobile device but some other device, such parameters can be considered within the withdrawal rules, thereby enabling streamlined point of sale transactions.

In some embodiments, the customer interface device is maintained by the merchant and is part of the point of sale such that the customer provides input potentially without needing an additional customer interface device. In such a situation, for example, where the customer carries a bank card for authentication into his accounts, the customer provides the bank card information to the customer interface device at the point of sale. In some such embodiments, the withdrawal rules are stored on a memory on the bank card, and the rules are applied automatically such that the appropriate budgeting accounts are debited during the transaction. In other embodiments, the customer interface device retrieves the withdrawal rules from the financial institution server and/or backend system of the bank and applies the rules. In yet other embodiments, the customer interface device communicates details regarding the transaction to the financial institution server, which retrieves the withdrawal rules and applies the withdrawal rules.

Block 540 represents debiting the one or more budgeting accounts based on the customer input and the customer payment information. In the example discussed above, withdrawal rules are applied to the transaction details and the appropriate budgeting accounts are debited in this step. In various embodiments, the rules are stored and/or applied in different locations by different devices, but typically the budgeting accounts are debited at the financial institution server and/or backend systems.

Block 550 represents communicating confirmation of transaction completion to the customer interface device, which in turn, communicates the same to the customer. The financial institution server and/or backend systems, upon completion of debiting the appropriate budgeting accounts communicates confirmation of the transaction to the customer interface device at the point of sale, which in turn communicates confirmation of completion of the transaction to the customer. In some embodiments, however, the financial institution server and/or backend systems do not actually complete the debiting process before communicating confirmation of the transaction completion to the customer interface device, but rather merely ensure sufficient funds, and in some embodiments, earmark those funds without completing the debiting process. In other embodiments, the entire transaction is completed locally at the point of sale, without the financial institution server and/or backend systems being involved during the transaction. Thus, the customer payment information is captured, and perhaps verified locally and thereafter communicated to the financial institution at a later time. The financial institution then debits the appropriate accounts.

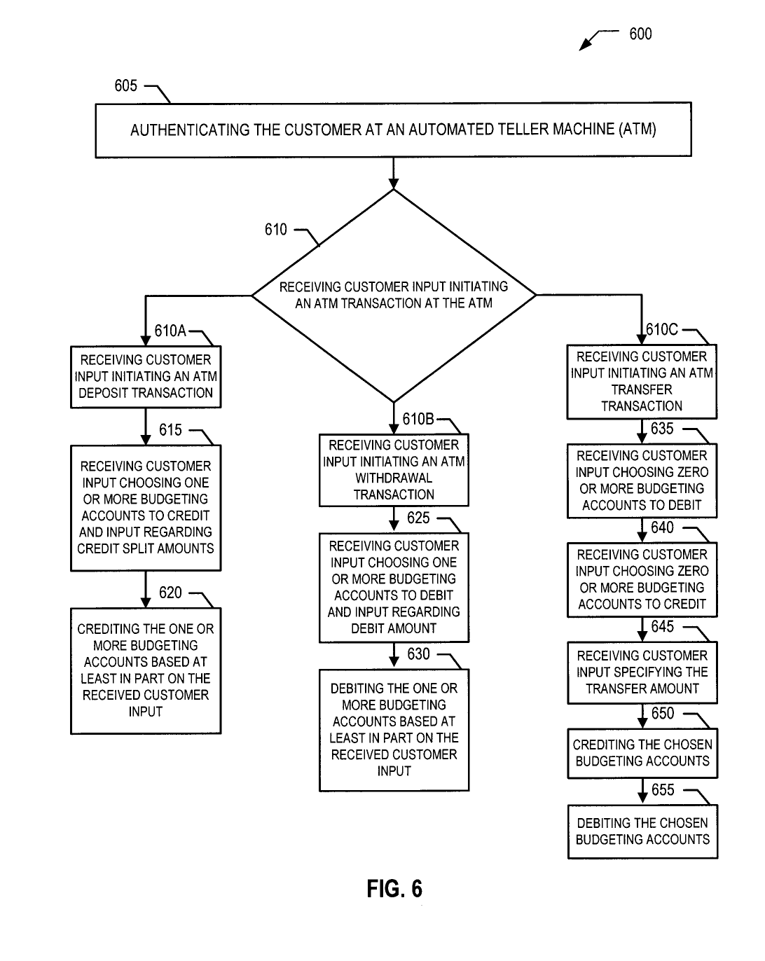

Referring now to FIG. 6, a flowchart illustrating a method 600 for providing an automated teller machine (ATM) transaction using one or more budgeting accounts according to one embodiment of the present invention is shown. Block 605 represents authenticating the customer at an ATM as discussed above. Decision block 610 represents receiving customer input initiating an ATM transaction at the ATM. Depending on the type of transaction desired by the customer, the method 600 follows one of the three branches beginning with blocks 610A, 610B, and 610C as illustrated in FIG. 6.

Block 610A represents receiving customer input initiating an ATM deposit transaction. This input is initially received by the ATM, but in some embodiments, is communicated to the financial institution server and/or backend system of the bank as well.

Block 615 represents receiving customer input choosing one or more budgeting accounts to credit and input regarding credit split amounts. This input is also initially received by the ATM and, in some embodiments, is communicated to the financial institution server and/or backend systems of the bank. The customer, of course, makes a deposit of some sort during the transaction, such as, for example, depositing a check and/or cash into the ATM. Once the amount of the deposit is determined, the ATM receives the customer input regarding whether the customer would like to split the credit amount over more than one budgeting and/or non-budgeting account. In some embodiments, the deposit split information is included in the funding rules predetermined by the customer such that the customer need not reiterate the deposit split information during the deposit transaction.

Block 620 represents crediting the one or more budgeting accounts based at least in part on the received customer input. Once the deposit transaction is complete the financial institution server and/or backend systems post the credits to the appropriate accounts in the amounts specified by the customer and/or the funding rules. In other embodiments, the credits to the one or more budgeting accounts are made before completion of the deposit transaction.

Referring now to the second prong of FIG. 6, block 610B represents receiving customer input initiating an ATM withdrawal transaction. This step, in most embodiments, involves the customer choosing an option on the ATM screen for making a withdrawal.

Block 625 represents receiving customer input choosing one or more budgeting accounts to debit and input regarding debit amount. Similar to step 610B, the customer is given the opportunity to provide input regarding which of the budgeting accounts from which to withdraw funds. In some embodiments, the withdrawal rules include parameters dictating which budgeting accounts from which to withdraw funds during an ATM withdrawal transaction. The withdrawal rules, as discussed elsewhere, in various embodiments, are stored locally on the customer's bank card, at the ATM, at the financial institution server, a combination of the foregoing or the like. The rules are applied either locally at the customer's bank card or the ATM, or remotely at the financial institution server. In one embodiment, for example, the parameters of the withdrawal rules dictate that for any ATM withdrawal of $100.00 or more, the withdrawal must come from a “Slush” budgeting account, whereas the customer is given the opportunity to choose which budgeting account from which to withdraw funds of less than $100.00. In some embodiments where withdrawal rules dictate some or all of the ATM withdrawal transaction parameters, the customer has the opportunity to override one or more of the parameters in order to withdraw funds as he or she desires. In such embodiments, particularly where the customer initially established the withdrawal rules, this override feature is appropriate. However, in certain other situations and embodiments, the customer is not allowed to override the withdrawal rules. For example, in one embodiment, the customer is a child and the budgeting accounts are managed by the child's parents. The parents have established both the funding and withdrawal rules. In one example, the parents have established withdrawal rules that prevent withdrawal of funds from any of the budgeting accounts in amounts over $40.00, or in another example, the parents have established withdrawal rules preventing the child from accessing, that is, withdrawing funds from several budgeting accounts owned by the parents, but the child is allowed to make qualifying withdrawals from, for example, “Billy's Money” budgeting account. In this regard, the budgeting accounts can be used as a sort of automatic allowance manager for families.

Block 630 represents debiting the one or more budgeting accounts based at least in part on the received customer input. Once the withdrawal transaction is complete the financial institution server and/or backend systems post the debits to the appropriate accounts in the amounts specified by the customer and/or the withdrawal rules. In other embodiments, the debits to the one or more budgeting accounts are made before completion of the withdrawal transaction.

Referring now to the third prong of FIG. 6, block 610C represents receiving customer input initiating an ATM transfer transaction. The transfer transaction is different from a deposit or withdrawal transaction because at least two accounts must be specified for the transfer to be effected, that is, the account to be debited and the account to be credited. Block 635 represents receiving customer input choosing zero or more budgeting accounts to debit. Block 640 represents receiving customer input choosing zero or more budgeting accounts to credit. Block 645 represents receiving customer input specifying the transfer amount. The customer input is received initially at the ATM, but in some embodiments, is communicated to the financial institution server and/or the bank's backend systems.

Block 650 represents crediting the chosen budgeting accounts, and block 655 represents debiting the chosen budgeting accounts. In some embodiments the accounts are credited and/or debited before completion of the transaction, that is, before the customer leaves the ATM, and in other embodiments, one or more of the involved accounts are debited and/or credited after completion of the transaction.

In some embodiments, a transfer transaction is carried out on a customer interface device other than an ATM. For example, the customer may be using the online banking website and chooses the transfer funds manually from one budgeting account to another budgeting account, or in another embodiment, from to or from a non-budgeting account from or to a budgeting account. In such embodiments, similar steps are used as steps 610C, 635, 640, 645, 650 and 655 except that the customer interface device is not an ATM but a customer computer system.

In some embodiments, the funding and/or withdrawal rules dictate some parameters of transfer transaction. For example, in one embodiment, the withdrawal rules dictate that any ATM transfer transaction associated with the customer must debit a budgeting account identified as the “Transfers” sub-account, but the customer is left to provide input regarding which of the budgeting accounts to transfer the funds into. That is, the funding rules are silent with regard to the crediting portion of the transfer transaction.

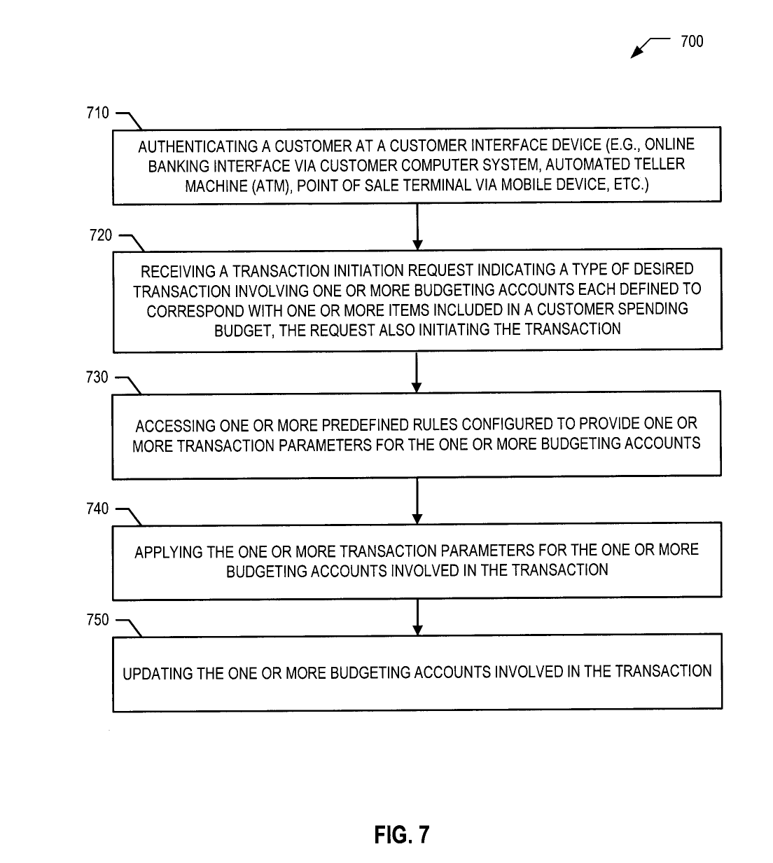

Referring now to FIG. 7, a flowchart illustrating a method 700 for applying one or more rules during a transaction involving one or more budgeting accounts according to another embodiment of the present invention is shown.

Block 710 represents authenticating a customer at a customer interface device such as an online banking interface via a customer computer system, an ATM, a point of sale terminal via a mobile device, a point of sale terminal without a mobile device or the like.

Block 720 represents receiving a transaction initiation request indicating a type of desired transaction involving one or more budgeting accounts each defined to correspond with one or more items included in a customer spending budget. The request also initiates the transaction. The type of transaction, in various embodiments, includes a debit transaction (such as a withdrawal transaction), a credit transaction (such as a deposit transaction), a transfer transaction, and the like.

Block 730 represents accessing one or more predefined rules configured to provide one or more transaction parameters for the one or more budgeting accounts. As discussed above, the predefined rules include funding rules and/or withdrawal rules, and in some embodiments, include transfer rules or other sub-categories of rules associated with either funding or withdrawal. The rules are predefined by the customer in some embodiments, and in others the rules are predefined by some other entity such as the customer's associate (e.g., by a parent of a child or an employer of an employee) or the bank maintaining the accounts. In some embodiments, the rules are stored proximate the customer on a customer device or customer interface device and in others the rules are stored remote from the customer at a financial institution server and/or backend system or both.

Block 740 represents applying the one or more transaction parameters for the one or more budgeting accounts involved in the transaction. This step is performed, in some embodiments, proximate the customer during a transaction. That is, a customer device such as a smartcard or mobile device or a customer interface device such as a mobile device, ATM, or customer computer system applies the rules. In other embodiments, the rules are applied remote to the customer, such as by the financial institution server and/or backend systems of the bank. In yet other embodiments the rules are applied by different processing devices, such as a processing device proximate the customer applies withdrawal rules and a processing device remote to the customer applies funding rules.

Block 750 represents updating the one or more budgeting accounts involved in the transaction. In some embodiments, this includes debiting appropriate budgeting accounts and crediting appropriate budgeting accounts as well as updating relevant information saved at the backend systems of the bank.

The various embodiments of the invention provide customers an opportunity to conduct various types of transactions with complete visibility regarding how the transactions affect their established budgets. In some embodiments, the customers provide funding and/or withdrawal rules that are “hard” or “soft” according to the customer's desires. A “hard” rule would typically be one that is applied regardless of the circumstances. In other words it is a “hard and fast” rule or one that takes highest priority over other rules or considerations. A “soft” rule, on the other hand, is one which has a lower priority and can be modified or possibly even ignored given appropriate transactional circumstances. For example, in the case where the customer has created and specified a budgeting account for his mortgage payment, the customer may choose to make funding and automatic payment to/from the mortgage sub-account the highest priority. The rules for funding and withdrawing funds to and from the mortgage account would be considered hard rules.

In another example, a budgeting account is earmarked for funding purchase of a television, and the customer desires the rules for funding and withdrawing funds into and out of that account to be softer than more important accounts. For example, in one instance, the customer desires to withdraw funds to see a movie, and the predetermined rules regarding priority dictate that the customer cannot withdraw funds from the mortgage sub-account but can withdraw funds from the television purchase sub-account. Of course, in some embodiments, the customer can override the rules and priorities as discussed above, but in others, the customer cannot override the rules and/or priorities at the point of sale or otherwise. In some instances, such a configuration can assist in deterring impulse purchases, because, at the point of sale, the customer will not be allowed by his or her predetermined rules and priorities to withdraw funds from budgeting accounts having “hard” rules. In some embodiments, the customer can log on to online banking and change the rules and/or priorities, which in the impulse purchasing example above, may provide sufficient time for the customer to cool to the purchase and avoid the impulse.

The customer, when establishing the rules is given the opportunity to specify the priority of the rules, and the priorities associated with the rules are stored as parameters to be applied during transactions. In one embodiment, the customer simply ranks her funding/withdrawal rules based on desired priority. In the example above, perhaps the mortgage funding and payment rules would be ranked very highly by the customer on such a list. In another example, the customer classifies the various funding and withdrawal rules and any other rules or parameters associated with the budgeting accounts such that application of the rules and parameters remains constant during a given set of transactional circumstances.

Embodiments of the present invention provide for assisting a customer with budgeting. The systems, methods and computer program products, in various embodiments include receiving, at a processor, customer input indicating the customer's desire to create one or more budgeting accounts each defined to correspond with one or more items included in a customer spending budget. The method also includes receiving, at a processor, customer input regarding one or more rules corresponding to the one or more budgeting accounts. The rules, in various embodiments, include one or more funding rules configured to provide parameters for dictating credits for one or more budgeting accounts and/or one or more withdrawal rules configured to provide parameters for dictating debits for one or more budgeting accounts. The method also includes creating, using a processor, one or more budgeting accounts based at least in part on the received customer input. In some embodiments, a processing device applies the rules during a transaction and updates the one or more budgeting accounts.

In some embodiments, each of the budgeting accounts is associated with various other options. For example, in various embodiments, each budgeting account is associated with “Notify Me” functionality, whereby the customer can specify circumstances for which the financial institution will notify the customer regarding status or activity regarding a specific budgeting account. For example, a customer can request a communication such as a text message, email or telephone call when a particular budgeting account is debited. Similarly, for example, in various embodiments, each budgeting account is associated with “Warn Me” functionality, whereby the customer can specify circumstances for which the financial institution will notify the customer regarding perceived nefarious activity regarding one or more of the customer's budgeting accounts. Likewise, in some embodiments, the budgeting accounts can be associated with “Prevent Me” functionality, which is similar to the rules-based prevention of certain activities within the budgeting accounts as discussed above. The “Prevent Me” functionality provides the customer an additional avenue for specifying rules for managing transactions involving the budgeting accounts. In some embodiments, the functionalities discussed above can be applied globally to all budgeting accounts or to more than one budgeting account. In some embodiments, the various rules and their parameters discussed above can also be applied globally or to groups of budgeting accounts without using functions such as “Notify Me”, “Warn Me”, “Prevent Me” and the like.

In various embodiments of the budgeting accounts, one or more accounts can be configured for additional functionality such as maximizing use of funds. For example, in one embodiment, a budgeting account's funds can be transferred or “swept” into a higher interest bearing account during periods of time when the funds are not being used for their intended purpose. For example, in a situation where a customer has a mortgage budgeting account that is funded on the 1^{st} and 15^{th} days of every month and which is debited for payment of the mortgage on the 5^{th} day of every month, the funds within the account can be swept into a higher interest bearing account after funding and swept back into the budgeting account in time for payment of the mortgage.

In some embodiments, the financial institution provides incentives for customers to use budgeting accounts such as providing a higher interest rate for budgeting accounts wherein only one debit is planned per month, such as, for example, in the case of mortgage budgeting account. In another example, an account having unlimited debits, but that is only credited once a month.

In some embodiments, the budgeting accounts are assigned rules based on behavioral questions posited to the customer by the financial institution. For example, the financial institution receives customer response regarding maintaining a balance in a particular budgeting account, or in another example, raising a balance in a particular budgeting account a specified amount every month. Such questions, asked at the creation of the budgeting accounts, or in some embodiments, at the request of the customer subsequent to creation of the budgeting accounts in order to assist the customer in establishing appropriate rules regarding the budgeting accounts in order to meet the customer's goals, dictate the rules that are used to define parameters applied during transactions.

In some embodiments, each sub-account is assigned a sub-account number, and the customer's checks are printed with a field for specifying the particular sub-account from which funds should be debited. In some embodiments, when a customer writes a check this overrides any conflicting predetermined rules restricting debiting of funds from particular sub-accounts, but in other embodiments, the check is not cleared and/or processed if rules restricting the transaction activity exist. In some such embodiments, the customer can be notified and provide an override to the rules or in other embodiments, the check bounces and the debit is not made based on the rules.

In some embodiments of the budgeting accounts, some or all of the rules discussed in various sections of this disclosure are not initiated, implemented, and/or used during debit and/or credit transactions. In one example, a budgeting account is identified as a “Power Bill” budgeting account, and the customer establishes an automatic transaction protocol with the power company to debit the Power Bill budgeting account every month. In such a case, the customer typically gives the power company the information necessary to debit the budgeting account such as, of course, the customer's consent as well as the budgeting account's account number and routing number. In some such embodiments, rules are established for funding one or more budgeting accounts and rules are either not established or not used in every situation for debiting the one or more budgeting accounts. In other embodiments, rules are established for debiting one or more budgeting accounts and rules are either not established or not used in every situation for crediting the one or more budgeting accounts.

Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As used herein, unless specifically limited by the context, the term “transaction” may refer to a purchase of goods and/or services (collectively referred to herein as “products”), a withdrawal of funds, an electronic transfer of funds, a payment transaction, a credit transaction, a PIN change transaction or other interaction between a cardholder and the bank maintained a bank account owned by the cardholder. As used herein, a “bank card” refers to a credit card, debit card, ATM card, check card, or the like, or other payment device such as, but not limited to, those discussed above that are not cards. An “account” or “bank account” refers to a credit account, debit account, deposit account, demand deposit account (DDA), checking account, budgeting account or the like. Although the phrases “bank card” and “bank account” include the term “bank,” the card or payment device need not be issued by a bank, and the account need not be maintained by a bank and may instead be issued by and/or maintained by other financial institutions.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for assisting a customer with budgeting, the method comprising:
receiving, at a processor, customer input indicating the customer's desire to create one or more budgeting accounts each defined to correspond with one or more items included in a customer spending budget;
receiving, at a processor, customer input regarding one or more rules corresponding to the one or more budgeting accounts; and
creating, using a processor, one or more budgeting accounts based at least in part on the received customer input.

2. The method of claim 1 wherein the one or more rules comprise one or more funding rules configured to provide parameters for dictating credits for one or more budgeting accounts.

3. The method of claim 2 wherein the funding rules are further configured to provide parameters dictating automatic, periodic credits for one or more budgeting accounts.

4. The method of claim 2 wherein the funding rules are further configured to provide parameters dictating automatic credits for one or more budgeting accounts, and wherein the method further comprises:
receiving a deposit into a primary account maintained by a financial institution;
applying the parameters provided by the funding rules comprising determining one or more amounts to be debited from the primary account and credited to the one or more budgeting accounts;
debiting the primary account based at least in part on applying the parameters; and
crediting the one or more budgeting accounts based at least in part on applying the parameters.

5. The method of claim 4 wherein the received deposit is an automatic direct deposit.

6. The method of claim 1 wherein the one or more rules comprise one or more withdrawal rules configured to provide parameters for dictating debits for one or more budgeting accounts.

7. The method of claim 6 wherein the withdrawal rules are further configured to provide parameters dictating automatic, periodic debits for one or more of the budgeting accounts.

8. The method of claim 6 further comprising:
receiving customer input from a customer interface device, the customer input comprising choosing one or more budgeting accounts to debit during completion of a transaction at a point of sale;
receiving customer payment information; and
debiting the one or more budgeting accounts based on the customer input and customer payment information.

9. The method of claim 8 further comprising:
communicating confirmation of transaction completion to the customer device.

10. The method of claim 2 further comprising:
authenticating the customer at an automated teller machine (ATM);
receiving customer input initiating an ATM deposit transaction at the ATM;
receiving customer input choosing one or more budgeting accounts to credit and input regarding credit split amounts; and
crediting the one or more budgeting accounts based at least in part on the received customer input.

11. The method of claim 1 further comprising:
authenticating the customer at an automated teller machine (ATM);
receiving customer input initiating an ATM transfer transaction at the ATM;
receiving customer input choosing zero or more budgeting accounts to credit and input regarding credit split amounts;
receiving customer input choosing zero or more budgeting accounts to debit;
receiving customer input specifying the transfer amount;
crediting the zero or more budgeting accounts based at least in part on the received customer input; and
debiting the zero or more budgeting accounts based at least in part on the received customer input.

12. The method of claim 6 further comprising:
authenticating the customer at an automated teller machine (ATM);
receiving customer input initiating an ATM withdrawal transaction at the ATM;
receiving customer input choosing one or more budgeting accounts to debit and input regarding debit amount; and
debiting the one or more budgeting accounts based at least in part on the received customer input.

13. A computer program product comprising a non-transitory computer-readable medium comprising computer executable instructions, the instructions for assisting a customer with budgeting, the instructions comprising:
instructions for receiving customer input indicating the customer's desire to create one or more budgeting accounts each defined to correspond with one or more items included in a customer spending budget;
instructions for receiving customer input regarding one or more rules corresponding to the one or more budgeting accounts; and
instructions for creating one or more budgeting accounts based at least in part on the received customer input.

14. The computer program product of claim 13 wherein the instructions for receiving customer input regarding one or more rules comprise instructions for receiving customer input regarding one or more funding rules configured to provide parameters for dictating credits for one or more budgeting accounts.

15. The computer program product of claim 14 wherein the instructions for receiving customer input regarding one or more rules comprise instructions for receiving customer input regarding one or more funding rules further configured to provide parameters dictating automatic, periodic credits for one or more budgeting accounts.

16. The computer program product of claim 14 wherein the instructions for receiving customer input regarding one or more rules comprise instructions for receiving customer input regarding one or more funding rules further configured to provide parameters dictating automatic credits for one or more budgeting accounts and wherein the instructions further comprise:
instructions for receiving a deposit into a primary account maintained by a financial institution;
instructions for applying the parameters provided by the funding rules comprising determining one or more amounts to be debited from the primary account and credited to the one or more budgeting accounts;
instructions for debiting the primary account based at least in part on applying the parameters; and
instructions for crediting the one or more budgeting accounts based at least in part on applying the parameters.

17. The computer program product of claim 16 wherein the received deposit is an automatic direct deposit.

18. The computer program product of claim 13 wherein the instructions for receiving customer input regarding one or more rules comprise instructions for receiving customer input regarding one or more withdrawal rules configured to provide parameters for dictating debits for one or more budgeting accounts.

19. The computer program product of claim 18 wherein the withdrawal rules are further configured to provide parameters dictating automatic, periodic debits for one or more of the budgeting accounts.

20. The computer program product of claim 18 wherein the instructions further comprise:
instructions for receiving customer input from a customer interface device, the customer input comprising choosing one or more budgeting accounts to debit during completion of a transaction at a point of sale;
instructions for receiving customer payment information; and
instructions for debiting the one or more budgeting accounts based on the customer input and customer payment information.

21. The computer program product of claim 20 wherein the instructions further comprise:
instructions for communicating confirmation of transaction completion to the customer device.

22. The computer program product of claim 14, wherein the instructions further comprise:
instructions for authenticating the customer at an automated teller machine (ATM);
instructions for receiving customer input initiating an ATM deposit transaction at the ATM;
instructions for receiving customer input choosing one or more budgeting accounts to credit and input regarding credit split amounts; and
instructions for crediting the one or more budgeting accounts based at least in part on the received customer input.

23. The computer program product of claim 13, wherein the instructions further comprise:
instructions for authenticating the customer at an automated teller machine (ATM);
instructions for receiving customer input initiating an ATM transfer transaction at the ATM;
instructions for receiving customer input choosing zero or more budgeting accounts to credit and input regarding credit split amounts;
instructions for receiving customer input choosing zero or more budgeting accounts to debit;
instructions for receiving customer input specifying the transfer amount;
instructions for crediting the zero or more budgeting accounts based at least in part on the received customer input; and
instructions for debiting the zero or more budgeting accounts based at least in part on the received customer input.

24. The computer program product of claim 18, wherein the instructions further comprise:
instructions for authenticating the customer at an automated teller machine (ATM);
instructions for receiving customer input initiating an ATM withdrawal transaction at the ATM;
instructions for receiving customer input choosing one or more budgeting accounts to debit and input regarding debit amount; and
instructions for debiting the one or more budgeting accounts based at least in part on the received customer input.

25. A system for assisting a customer with budgeting, the system comprising:
a processing device configured for:
receiving customer input indicating the customer's desire to create one or more budgeting accounts each defined to correspond with one or more items included in a customer spending budget;
receiving customer input regarding one or more rules corresponding to the one or more budgeting accounts; and
creating one or more budgeting accounts based at least in part on the received customer input.

26. The system of claim 25 wherein the processing device is further configured for receiving one or more funding rules configured to provide parameters for dictating credits for one or more budgeting accounts.

27. The system of claim 26 wherein the processing device is further configured for receiving one or more funding rules configured to provide parameters dictating automatic, periodic credits for one or more budgeting accounts.

28. The system of claim 26 wherein the processing device is further configured for:
receiving one or more funding rules configured to provide parameters dictating automatic credits for one or more budgeting accounts;
receiving a deposit into a primary account maintained by a financial institution;
applying the parameters provided by the funding rules comprising determining one or more amounts to be debited from the primary account and credited to the one or more budgeting accounts;
debiting the primary account based at least in part on applying the parameters; and
crediting the one or more budgeting accounts based at least in part on applying the parameters.

29. The system of claim 28 wherein the received deposit is an automatic direct deposit.

30. The system of claim 25 wherein the processing device is further configured for receiving one or more withdrawal rules configured to provide parameters for dictating debits for one or more budgeting accounts.

31. The system of claim 30 wherein the withdrawal rules are further configured to provide parameters dictating automatic, periodic debits for one or more of the budgeting accounts.

32. The system of claim 30 further comprising:
a point of sale terminal coupled with the first processing device, the point of sale terminal comprising:
a second processing device configured for:
receiving customer input from a customer interface device, the customer input comprising choosing one or more budgeting accounts to debit during completion of a transaction at the point of sale terminal;
receiving customer payment information; and the first processing device further configured for:
debiting the one or more budgeting accounts based on the customer input and customer payment information.

33. The system of claim 32 further comprising:
a communication device coupled with the customer interface device and configured for communicating confirmation of transaction completion to the customer interface device.

34. The system of claim 26 further comprising:
a customer interface device coupled with the processing device, the customer interface device configured for:
authenticating the customer;
receiving customer input initiating a deposit transaction at the customer interface device;
receiving customer input choosing one or more budgeting accounts to credit and input regarding credit split amounts; wherein the processing device is further configured for:
crediting the one or more budgeting accounts based at least in part on the received customer input.

35. The system of claim 25 further comprising:
a customer interface device coupled with the processing device, the customer interface device configured for:
authenticating the customer at the customer interface device;
receiving customer input initiating a transfer transaction at the customer interface device;
receiving customer input choosing zero or more budgeting accounts to credit and input regarding credit split amounts;
receiving customer input choosing zero or more budgeting accounts to debit;
receiving customer input specifying the transfer amount; and wherein the processing device is further configured for:
crediting the zero or more budgeting accounts based at least in part on the received customer input; and
debiting the zero or more budgeting accounts based at least in part on the received customer input.

36. The system of claim 30 further comprising:
a customer interface device coupled with the processing device, the customer interface device configured for:
authenticating the customer at the customer interface device;
receiving customer input initiating a withdrawal transaction at the customer interface device;
receiving customer input choosing one or more budgeting accounts to debit and input regarding debit amount; and wherein the processing device is further configured for:
debiting the one or more budgeting accounts based at least in part on the received customer input.

37. A method for assisting a customer with budgeting, the method comprising:
receiving, using a processor, a transaction initiation request initiating a transaction involving one or more of a customer's one or more budgeting accounts each defined to correspond with one or more items included in a customer spending budget;
accessing, using a processor, one or more predefined rules configured to provide one or more transaction parameters for the one or more budgeting accounts;
applying, using a processor, the one or more transaction parameters for the one or more budgeting accounts involved in the transaction; and
updating, using a processor, the one or more budgeting accounts involved in the transaction.

38. The method of 37 further comprising:
authenticating a customer at a customer interface device; and wherein receiving a transaction initiation request initiating a transaction comprises:
receiving, at a processor, customer input indicating a type of desired transaction involving the one or more budgeting accounts.

39. The method of claim 38 wherein the customer interface device comprises an online banking interface.

40. The method of claim 38 wherein the customer interface device comprises an automated teller machine (ATM).

41. The method of claim 38 wherein the customer interface device comprises a point of sale terminal.
